(19) United States
(12) Patent Application Publication
(10) Pub. No.: US 2025/0316397 A1
(43) Pub. Date: Oct. 9, 2025

(54) METHOD AND SYSTEM FOR MONITORING A NUCLEAR PLANT, WITH DETECTION AND CHARACTERIZATION OF AN IMBALANCE

(71) Applicant: FRAMATOME, COURBEVOIE (FR)

(72) Inventor: Jean FEINGOLD, MONTROUGE (FR)

(21) Appl. No.: 18/689,854

(22) PCT Filed: Sep. 7, 2022
(86) PCT No.: PCT/EP2022/074781

§ 371 Date: Oct. 3, 2024

(30) Foreign Application Priority Data
Sep. 7, 2021 (FR) FR2109360

(51) Int. Cl. G21D 3/00; G21D 3/04; G21D 3/08

(52) U.S. Cl. CPC G21D 3/001; G21D 3/04; G21D 3/08

(57) ABSTRACT

A method for monitoring a nuclear plant includes, for each steam generator from among a plurality of steam generators and for at least one of the parameters of a set of parameters representative of operating of the steam generator, determining a deviation between a measured value of the parameter for this steam generator and the average value of this parameter for all the steam generators to detect an imbalance of this parameter on the steam generator; and characterizing the imbalance as a function of one or more other parameters in the set of representative parameters, so as to generate a physical problem signal or a measurement drift signal.

### CROSS-REFERENCE TO RELATED APPLICATIONS

This application is the U.S. National Phase of PCT Appl. No. PCT/EP2022/074781 filed Sep. 7, 2022, which claims priority to FR 21 09360, filed Sep. 7, 2021, the entire disclosures of which are incorporated by reference herein.

### TECHNICAL FIELD

The present disclosure relates to the field of monitoring a nuclear plant.

### BACKGROUND

A nuclear plant has a primary water circuit (or “primary circuit”) and a secondary water circuit (or “secondary circuit”) which are separate, a nuclear reactor to heat the water circulating in the primary circuit, several steam generator(s) arranged to transfer heat from the primary circuit to the secondary circuit and generate steam in the secondary circuit, and a steam turbine integrated in the secondary circuit to generate mechanical energy from the steam generated by the steam generators. This mechanical energy can then be converted into electrical energy using an electrical generator coupled to the steam turbine.

### SUMMARY

A nuclear plant is generally equipped with sensors measuring operating parameters used to monitor and control the nuclear plant.

These operating parameters are used, for example, by a monitoring system configured to automatically monitor and/or control the nuclear plant.

One of the aims of the present disclosure is to propose a method for monitoring a nuclear plant implemented by a monitoring system, which allows monitoring to be carried out in a reliable manner.

To this end, the present disclosure proposes a method for monitoring a nuclear plant implemented by a monitoring system, the nuclear plant having a primary circuit, a secondary circuit, a nuclear reactor arranged in the primary circuit to heat water circulating in the primary circuit, and N steam generators arranged to transfer heat from the primary circuit to the secondary circuit by generating steam in the secondary circuit, N being an integer equal to or greater than 2, the monitoring system comprising sensors for measuring, for each steam generator, parameters of a set of parameters representative of the steam generator operation, the monitoring method comprising, for at least one of the parameters of the set of representative parameters, and for each steam generator:
determining, as a function of the measurements supplied by the sensors, a deviation between a measured value of the parameter for this steam generator and the average value of this parameter for all the steam generators, in order to detect an imbalance of this parameter on the steam generator; and
characterizing the imbalance affecting this steam generator parameter as a function of one or more other parameters in the set of representative parameters, in such a manner as to generate a physical problem signal indicative of the presence of a physical problem on the steam generator affected by the imbalance, or a measurement deviation signal indicative of a deviation in the measurement of the parameter under consideration on the steam generator affected by the imbalance.

By comparing the measured value of a steam generator parameter with the average value of this parameter for all the steam generators, it allows an imbalance of this parameter on this steam generator to be identified.

Such an imbalance may be due to a physical problem on this steam generator, that is, a problem actually present on this steam generator affected by the imbalance, or to a deviation in the measurement of said parameter on this steam generator, that is, a measurement error of a sensor, the measurement of which determines the value of this parameter.

Each other parameter taken into account for the characterization of an imbalance detected on the parameter under consideration is preferably another parameter linked to said parameter under consideration and which should in principle also be affected by the imbalance.

Characterizing the imbalance on a steam generator parameter as a function of one or more other parameters allows the monitoring system to automatically generate a signal indicating that the imbalance detected is due to a physical problem on the steam generator or to a deviation in the measurement of this parameter on this steam generator.

Characterizing the imbalance thus allows an operator or the monitoring system to control the nuclear plant to take appropriate measures following the detection of an imbalance, according to whether it is a physical problem or a measurement deviation.

In the case of characterizing a physical problem, the nuclear plant can be controlled to compensate for the physical problem, or the nuclear plant can be switched to an operating mode allowing the physical problem to be corrected. In the case of characterizing a measurement deviation, it is possible to correct the measurement carried out or the faulty equipment can be serviced (repaired or replaced) in a power-on or power-off state.

According to particular modes of implementation, the monitoring method comprises one or more of the following optional features, taken individually or according to any technically possible combination:
for at least one of the parameters of the set of representative parameters, the characterization of a parameter imbalance is carried out as a function, for at least one or each of said other parameter(s), of a deviation between a measured value of this other parameter for the steam generator under consideration and a reference value of this other parameter for all the steam generators, the reference value being chosen from among an average value of this other parameter and a setpoint value of this other parameter;
the monitoring method comprises comparing at least one or each deviation between a measured value and a reference value of a parameter with one or more comparison threshold(s), to detect an imbalance on this parameter or to detect an imbalance on another parameter, the reference value being chosen from among an average value and a setpoint value of this parameter, the reference value being chosen from among an average value and a setpoint value of the parameter concerned;
for at least one of the parameters in the set of representative parameters, characterizing the imbalance of the parameter on the steam generator under consideration comprises:
emission of a physical problem signal if the deviation calculated for this parameter is less than a lower threshold associated with this parameter or greater than an upper threshold associated with this parameter, and if the deviation between the measured value and a reference value of this other parameter of the set of representative parameters, preferably chosen from among the average values calculated for this other parameter and a setpoint value of this other parameter, possibly filtered using a phase advance filter, is less than a lower threshold associated with this other parameter or greater than an upper threshold associated with this other parameter; and/or
the emission of a measurement drift signal if the deviation calculated for this parameter is less than a lower threshold associated with this parameter or greater than an upper threshold associated with this parameter, and if the deviation between the measured value and a reference value of another parameter of the set of representative parameters, preferably chosen from among the average values calculated for said other parameter and a setpoint value of said other parameter, possibly filtered using a phase advance filter, is not less than the lower threshold associated with this other parameter nor greater than the upper threshold associated with this other parameter;
for each steam generator, and for at least one of the parameters of the set of representative parameters, characterizing an imbalance of this parameter on this steam generator comprises:
the emission of a first physical problem signal if the deviation between the measured value and the calculated average value for this parameter is less than a negative lower threshold, and if the deviation between the measured value and a reference value of another parameter of the set of representative parameters, preferably chosen from among the calculated average value for this other parameter and a setpoint value of this other parameter, possibly filtered using a phase advance filter, is less than a negative lower threshold;
the emission of a first measurement drift signal if the deviation between the measured value and the calculated average value for this parameter is less than the negative lower threshold, and if the deviation between the measured value and the reference value for the other parameter, possibly filtered using a phase advance filter, is not less than the negative lower threshold;
the emission of a second physical problem signal if the deviation between the measured value and the calculated average value for this parameter is greater than a positive upper threshold and if the deviation between the measured value and the reference value for the other parameter, possibly filtered using a phase advance filter, is greater than a positive upper threshold; and/or
the emission of a second measurement drift signal if the deviation between the measured value and the calculated average value for this parameter is greater than a positive upper threshold and if the deviation between the measured value and the reference value for the other parameter, possibly filtered using a phase advance filter, is not greater than the upper positive threshold.
for each steam generator and for at least one of the parameters of the set of representative parameters, the emission of an alarm signal if the deviation between the measured value and the reference value is less than a lower alarm threshold and/or the issuing of an alarm signal if the deviation between the measured value and the reference value is greater than an upper alarm threshold, the reference value being chosen from among an average value of this parameter and a setpoint value of this parameter;
the deviation between the measured value and the reference value is filtered using a phase advance filter before being compared with the lower alarm threshold and/or before being compared with the upper alarm threshold;
the characterization of an imbalance on at least one or each of the parameters of the set of representative parameters comprises taking into account an alarm signal emitted for another parameter of the set of representative parameters;
for each steam generator and for at least one of the parameters of the set of representative parameters, emission of a deviation signal if the deviation between the measured value and a reference value of this parameter is less than a lower deviation threshold and/or emission of a deviation signal if the deviation between the measured value and the reference value of this parameter is greater than an upper deviation threshold, the reference value being chosen from among an average value of this parameter and a setpoint value of this parameter;
the characterization of an imbalance of at least one of the parameters of a steam generator is carried out as a function of a deviation signal issued for this parameter and of an alarm or deviation signal issued for at least one other parameter taken into account for the characterization;
for each steam generator, the set of representative parameters comprises one or more of the following parameters: steam flow, steam pressure, feed water flow, feed water temperature, purge flow, level of water in the liquid state and primary power;
the characterization of an imbalance in the steam pressure of a steam generator is carried out, for example, as a function of the steam flow and the primary power, in particular, as a function of a deviation between the measured steam flow of this steam generator and the average steam flow of the steam generators, and of a deviation between the measured primary power of this steam generator and the average primary power for all the steam generators;
the characterization of an imbalance on the steam flow of a steam generator is carried out as a function of, for example, the steam pressure and the primary power, in particular, as a function of a deviation between the measured steam pressure of this steam generator and the average steam pressure of all the steam generators and a deviation between the measured primary power of this steam generator and the average primary power of the steam generators;
the characterization of an imbalance in the feed water temperature of a steam generator is carried out, for example, as a function of the primary power, in particular, as a function of a deviation between the measured primary power of this steam generator and the average primary power of all the steam generators;
the characterization of an imbalance in the feed water flow of a steam generator is carried out, for example, as a function of the water level of this steam generator, in particular, as a function of a deviation between a measured water level of this steam generator and a water level setpoint;
the characterization of an imbalance in the purge flow of a steam generator is carried out as a function of the feed water flow of this steam generator, in particular, as a function of a deviation between the measured feed water flow of this steam generator and the average feed water flow of all the steam generators.

The present disclosure also relates to a nuclear plant monitoring system, comprising sensors for measuring, for each steam generator, the parameters of the set of representative parameters, and an electronic monitoring unit configured to implement a monitoring method such as defined above from the measurements supplied by the sensors.

The present disclosure also relates to a computer program product that can be stored on a memory or data storage medium and executed by a processor or a computer, the computer program product comprising software code instructions for implementing a monitoring method such as defined above.

### BRIEF SUMMARY OF THE DRAWINGS

The present disclosure and its advantages will be better understood on reading the following description, given solely by way of non-limiting example, and made with reference to the appended drawings, in which:

FIG. 1 is a schematic view of a nuclear plant having a monitoring system configured to implement a monitoring method;

FIG. 2 is a block diagram illustrating the steps in the monitoring method; and

FIGS. 3 to 6 illustrate an electronic monitoring unit of the monitoring system, configured to implement the monitoring method.

### DETAILED DESCRIPTION

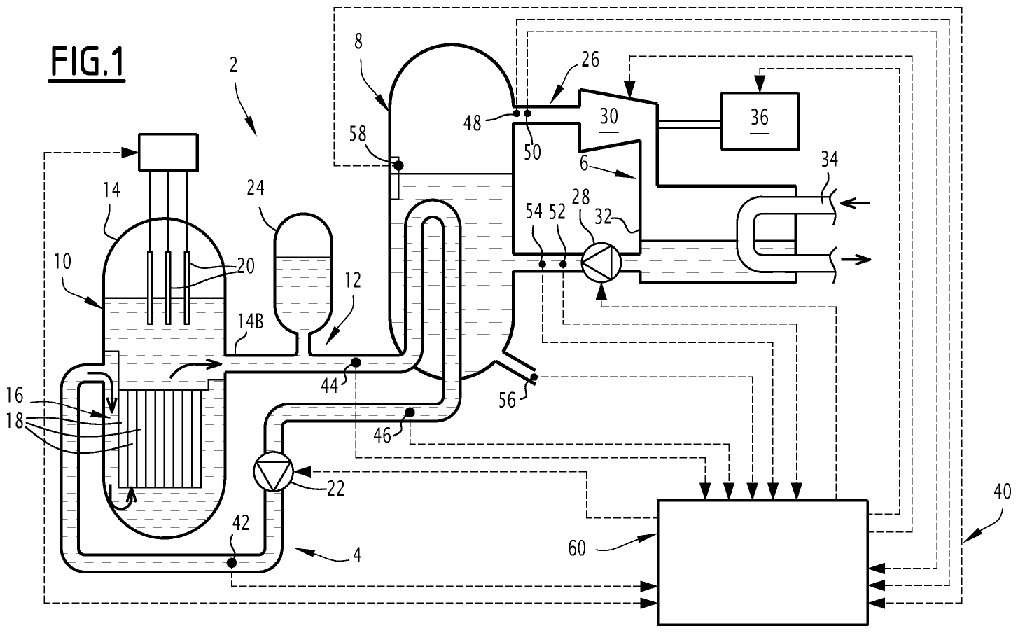

The nuclear plant 2 illustrated in FIG. 1 comprises a primary circuit 4 for water circulation and a secondary circuit 6 for water circulation, the primary circuit 4 and the secondary circuit 6 being separated and thermally coupled by means of N steam generator(s) 8, N being an integer equal to or greater than 2. N is for example equal to 4.

A single steam generator 8 is shown in FIG. 1 to simplify the drawings.

Each steam generator 8 is arranged between the primary circuit 4 and the secondary circuit 6 and is configured for heat exchange between the water in the primary circuit 4 and the water in the secondary circuit 6.

In operation, each steam generator 8 allows steam to be generated in the secondary circuit 6, in which the steam generator 8 is supplied at the inlet with water in the liquid state and supplies water at the outlet in the gaseous state, that is, steam.

The primary circuit 4 comprises a nuclear reactor 10 for heating the water circulating in the primary circuit 4.

The nuclear plant 2 is, for example, a pressurized water nuclear plant, in which case the nuclear reactor 10 is a pressurized water reactor (PWR), or a boiling water nuclear plant, in which case the nuclear reactor 10 is a boiling water reactor (BWR).

The primary circuit 4 comprises N primary fluid loop(s) 12, each primary loop 12 fluidly connecting the nuclear reactor 10 to a respective steam generator 8.

The nuclear reactor 10 comprises a reactor vessel 14 and a core 16 formed by a plurality of nuclear fuel assemblies 18 arranged side by side in the reactor vessel 14.

The nuclear reactor 10 comprises control clusters 20 able to be lowered into or raised out of the reactor core 16 to control the reactivity of the nuclear reactor 10. The control clusters 20 comprise, for example, control clusters able to be selectively inserted into the core 16 to decrease reactivity or extracted from the core 16 to increase reactivity, and shutdown clusters able to be released into the core 16 to cause automatic shutdown of the nuclear reactor 10.

Each primary loop 12 connects the reactor vessel 14 to a respective steam generator 8. Each primary loop 12 comprises a respective primary pump 22 to force water circulation within this primary loop 12.

When the nuclear plant 2 is a pressurized water reactor, the primary loop 4 comprises a pressurizer 24 configured to maintain, in the primary loop 4, a sufficient pressure so that the water circulating in the primary loop 4 remains in a liquid state.

The pressurizer 24 is fluidly connected to a hot branch of a primary loop 12, that is, a branch in which fluid flows from the nuclear reactor 10 toward the steam generator 8 located on this primary loop 12.

The secondary circuit 6 comprises N secondary loops 26, each secondary loop 26 being associated with a respective primary loop 12. Each steam generator 8 is interposed between a primary loop 12 and the associated secondary loop 26.

The secondary circuit 6 comprises one or more secondary pumps 28 to force water circulation within the secondary circuit 6. For example, the secondary circuit 6 comprises a respective secondary pump 28 in each secondary loop 26. Alternatively, one or more secondary pump(s) 28 supply all the secondary loops 26.

The secondary circuit 6 comprises a turbine 30 configured to convert thermal energy contained in the steam circulating in the secondary circuit 6 into mechanical energy.

An inlet of the turbine 30 is connected to the secondary loops 26 by means of an inlet manifold (or “barrel”) (not shown) configured to collect steam produced by the steam generators 8 and to supply the collected steam to the turbine 30.

The secondary circuit 6 comprises a condenser 32 configured in particular, to cool the steam leaving the turbine 30, and possibly the steam leaving the steam bypass unit (not shown) and return the water to the liquid state before returning the water in the liquid state to the steam generators 8 by means of the secondary loops 26.

The steam bypass unit is a part of the circuit allowing to bypass the turbine 30 between a steam header (not shown) provided to collect the steam coming from the plurality of steam generators 8 and the condenser 32, as a function of the desired steam flow through the turbine 30.

An outlet from the condenser 32 is connected to the secondary loops 26 by means of an outlet manifold (not shown) configured to distribute the water leaving the condenser 32 toward the various secondary loops 26.

Each condenser 32, for example, is arranged on the secondary circuit 6 being configured for heat exchange between the water of the secondary circuit 6 and the water circulating in a cooling circuit 34.

The nuclear plant 2 comprises an electrical generator 36 mechanically coupled to a turbine 30 so as to generate electrical energy from the mechanical energy generated by this turbine 30. The electrical energy is supplied, for example, to an electricity distribution network.

The nuclear plant 2 comprises a monitoring system 40 configured for automatic monitoring of the nuclear plant 2, in particular for implementing a monitoring method the nuclear plant 2.

The monitoring system 40 comprises sensors for measuring operating parameters of the nuclear plant 2, and, in particular, parameters representative of the operation of each steam generator 8.

The sensors comprise, for example, for each steam generator 8:
a primary water flow sensor 42 for measuring the water flow Q1 in the primary loop 12 in which this steam generator 8 is located;
an incoming water temperature sensor 44 to measure the water temperature in the hot branch TC, that is, the water temperature in the hot branch of the primary loop 12 carrying water from the reactor 10 toward the steam generator 8;
an outgoing water temperature sensor 46 for measuring the water temperature in the cold branch TF, that is, the water temperature in the cold branch of the primary loop 12 carrying water from the steam generator 8 toward the nuclear reactor 10;
a steam pressure sensor 48 for measuring the steam pressure PV, that is, the steam pressure at the outlet of the steam generator 8 in the secondary loop 26 in which the steam generator 8 is located;
a steam flow sensor 50 for measuring the steam flow DV, that is, the steam flow at the outlet of the steam generator 8 in the secondary loop 26 in which this steam generator 8 is located;
a feed water temperature sensor 52 for measuring the feed water temperature TE, that is, the temperature of the water in the liquid state arriving at the steam generator 8 in the secondary loop 26 in which this steam generator 8 is located;
a feed water flow sensor 54 for measuring the feed water flow DE, that is, the flow of the water in the liquid state arriving at the steam generator 8 in the secondary loop 26 in which this steam generator 8 is located;
a purge flow sensor 56 for measuring the purge flow DP of the steam generator 8. The purge flow DP is a flow of water in liquid state extracted from the secondary side of the steam generator 8. This purge flow DP is relatively low, especially compared with the steam flow extracted from the steam generator 8;
a water level sensor 58 for measuring the water level in the liquid state NV in the steam generator 8, on the side of the secondary loop 26.

It should be noted that in the patent application, unless otherwise stipulated, the term “flow” is used to refer to the mass flow of a fluid.

The monitoring system 40 comprises an electronic monitoring unit 60 configured to monitor the nuclear plant 2 by implementing the monitoring method.

The electronic monitoring unit 60 is configured, for example, to receive the measurement signals supplied by the sensors located on the nuclear plant 2 and representative of the operation of each steam generator 8, namely, respectively for each steam generator 8, the primary water flow sensor 42, the incoming water temperature sensor 44, the outgoing water temperature sensor 46, the steam pressure sensor 48, the steam flow sensor 50, the feed water temperature sensor 52, the feed water flow sensor 54, the purge flow sensor 56 and/or the water level sensor 58.

The electronic monitoring unit 60 is configured, for example, for each steam generator, to detect an imbalance in at least one parameter of this steam generator 8 by comparing the measured value of this parameter for this steam generator 8 with the average value of this parameter for all the steam generators, and characterizing such an imbalance as a function of at least one other operating parameter of the steam generator 8 by emitting a physical problem signal and a measurement drift signal, as a function of the measurement signals received by the electronic monitoring unit 60.

The electronic monitoring unit 60 is preferably configured for emission of alarm signals and deviation signals, preferably in such a way that they are perceptible by a human operator and/or, possibly, for the automatic control of the primary circuit 4 and/or the secondary circuit 6, as a function of the detection of an imbalance on a parameter of a steam generator relative to the average value of this parameter on all the steam generators 8.

The electronic monitoring unit 60 is configured, for example, to control the control clusters 20 to adjust or verify the reactivity of the nuclear reactor, to control each primary pump 22 to adjust or verify the water flow in each primary loop 12 of the primary circuit 4, to control each secondary pump 28 to adjust or verify the water flow and/or the water temperature in each secondary loop 26 of the secondary circuit 6, to control each turbine 30 and/or to control each generator 36, to adjust or verify the steam flow and/or the steam pressure in each loop 26 of the secondary circuit 6.

The electronic monitoring unit 60 comprises, for example, an data processing unit comprising a processor, a memory and a computer program product, that is, one or more software application(s), recordable on the memory or on a computer data medium and containing software code instructions executable by the processor when recorded on the memory. Alternatively, or optionally, the electronic monitoring unit 60 comprises, for example, a programmable logic circuit (for example, an in situ programmable gate array) and/or an integrated circuit.

In the case of a computer program product, this contains software code instructions for implementing the monitoring method.

Preferably, the monitoring method is implemented during steady-state operation of the nuclear plant 2, that is, during a period when the power generated by the nuclear reactor 10 is stabilized.

During operation, each steam generator 8 receives primary power P1 from the primary circuit 4, extracts secondary power P2 toward the secondary circuit 6, and supplies transferred power PS to the secondary circuit 6.

For each steam generator 8, the primary power P1 supplied by the primary circuit 4 to this steam generator 8 is a function of the water flow Q1 in the primary loop 12 supplying this steam generator 8, the water temperature in the hot branch TC of the primary loop 12, and the water temperature in the cold branch TF of the primary loop 12.

For each steam generator 8, the primary power P1 can be calculated, for example, according to the equation P1=K1*Q1*(TC−TF) where Q1 is the water flow measured in the primary loop, TC is the water temperature in the hot branch of the primary loop, TF is the water temperature in the cold branch of the primary loop, and K1 is a proportionality coefficient.

In steady-state operation, the secondary power P2 and the transferred power PS are substantially equal, and, for each steam generator 8, the secondary power P2 is determined, for example, by the equation P2=DV*HV+DP*HP−DE*HE, where DV is the steam flow leaving the steam generator, HV is the enthalpy of the steam leaving the steam generator, which is a function of the steam pressure and temperature at the steam generator outlet, DE is the feed water flow, that is, the flow of water in the liquid state into the steam generator 8 in the secondary circuit 6, HE is the enthalpy of the feed water which is a function of the pressure and temperature of the water in a liquid state entering into the steam generator 8, DP is the purge flow, HP is the purge enthalpy.

In steady-state operation, for each steam generator 8, the feed water flow DE is equal to the sum of the steam flow DV and the purge flow DP, and the following equation is therefore satisfied: DV+DP=DE.

Furthermore, each steam generator 8 presents a water level in liquid state NV, which should preferably follow a set water level NVcons.

For each steam generator 8, a set of parameters representative of the operation of this steam generator 8 comprises one or more of the following parameters: the steam flow DV, the steam pressure PV, the feed water flow DE, the feed water temperature TE, the purge flow DP, the water level in liquid state NV and the primary power P1.

For each steam generator 8, the value of each parameter is a function of the measurement(s) provided by one or more of the measurement sensors from among the measurement sensors of the nuclear plant 2, namely, respectively for each steam generator 8, the primary water flow sensor 42, the incoming water temperature sensor 44, the outgoing water temperature sensor 46 of the primary loop 12 in which the steam generator 8 is located, the steam pressure sensor 48, the steam flow sensor 50, the feed water temperature sensor 52, the feed water flow sensor 54, the purge flow sensor 56 and/or the water level sensor 58 of the secondary loop 26 in which the steam generator 8 is located.

Hereinafter, the measured value of a parameter of a steam generator corresponds to the value of the parameter determined for this steam generator 8 as a function of the measurement(s) supplied by one or more of the measurement sensors from among the measurement sensors of the nuclear plant 2.

In addition, the average value of a parameter is the average of the measured values of this parameter for all the steam generators 8.

For each parameter, the suffix “mes” is added to designate the measured value of this parameter for a steam generator 8 under consideration, and the suffix “avg” is added to designate the average value of this parameter for all the steam generators 8.

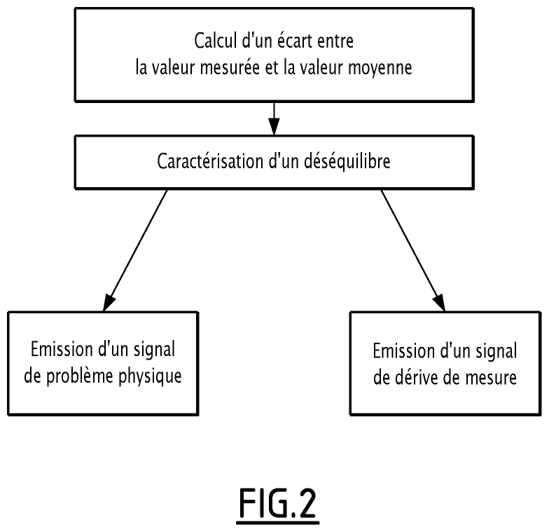

As illustrated in FIG. 2, the monitoring method comprises, for at least one parameter from among the parameters of the representative set of parameters, and for each steam generator 8:
calculating a deviation as the difference between the measured value of this parameter for this steam generator 8 and the average value of this parameter for all the steam generators 8, so as to detect an imbalance of this parameter on this steam generator 8, and
characterizing an imbalance of the parameter on the steam generator 8 as a function of one or more other parameters from among the parameters of the set of representative parameters, so as to generate a physical problem signal indicative of the presence of a physical problem on the steam generator 8 affected by the imbalance, or a measurement drift signal indicative of a drift in the measurement of the value of the operating parameter on the steam generator 8 affected by the imbalance.

The monitoring method comprises, for example, comparing the deviation between the measured value and the average value of the parameter with one or more comparison thresholds, to determine a potential imbalance situation or an actual imbalance situation.

In one example of the embodiment, for each steam generator 8, and for at least one of the parameters in the set of representative parameters, characterizing an imbalance of this parameter on this steam generator 8 comprises, for example:
emission of a physical problem signal if the deviation between the measured value and the calculated average value for this parameter is less than a lower threshold associated with this parameter or greater than an upper threshold associated with this parameter, and if the deviation between the measured value and a reference value of another parameter of the set of representative parameters, possibly filtered using a phase advance filter, is less than a lower threshold associated with this other parameter or greater than an upper threshold associated with this other parameter, the reference value preferably being chosen from among the average value calculated for the said other parameter or a setpoint value of the said other parameter; and/or
the emission of a measurement drift signal if the deviation between the measured value and the calculated average value for this parameter is less than a lower threshold associated with this parameter or greater than an upper threshold associated with this parameter, and if the deviation between the measured value and the reference value of another parameter of the set of representative parameters, possibly filtered using a phase advance filter, is not less than the lower threshold associated with this other parameter nor greater than the upper threshold associated with this other parameter, the reference value preferably being chosen from among the average value of said other parameter or a setpoint value of said other parameter.

One such characterization is carried out, for example, for the feed water temperature TE, the steam pressure PV, the steam flow DV and/or the purge flow DP.

A phase advance filter here designates an advance delay filter configured to introduce a phase advance into the signal filtered by the filter.

In one embodiment, for each steam generator 8, and for at least one of the parameters in the set of representative parameters, characterizing an imbalance of this parameter on this steam generator 8 comprises, for example:
the emission of a first physical problem signal if the deviation between the measured value and the average value calculated for this parameter is less than a negative lower threshold associated with said parameter, and if the deviation between the measured value and a reference value of another parameter of the set of representative parameters, possibly filtered using a phase advance filter, is less than a negative lower threshold associated with said other parameter, the reference value preferably being chosen from among the average value calculated for said other parameter or a setpoint value of said other parameter;
the emission of a first measurement drift signal if the deviation between the measured value and the calculated average value for this parameter is less than the negative lower threshold associated with said parameter and if the deviation between the measured value and the reference value for the other parameter, possibly filtered using a phase advance filter, is not less than said negative lower threshold associated with said other parameter;
the emission of a second physical problem signal if the deviation between the measured value and the calculated average value for this parameter is greater than a positive upper threshold associated with said parameter and if the deviation between the measured value and the reference value for the other parameter, possibly filtered using a phase advance filter, is greater than a positive upper threshold associated with said other parameter; and/or
the emission of a second measurement drift signal if the deviation between the measured value and the calculated average value for this parameter is greater than the positive upper threshold associated with said parameter and if the deviation between the measured value and the reference value for the other parameter, possibly filtered using a phase advance filter, is not greater than said positive upper threshold associated with said other parameter.

Such a characterization is carried out, for example, for the feed water flow DE of at least one steam generator 8, the other parameter taken into account for the characterization being the level of water in the liquid state NV in this steam generator 8.

Alternatively, or optionally, for each steam generator 8, and for at least one of the parameters of the set of representative parameters, the characterization of an imbalance of this parameter on this steam generator 8 comprises, for example:
the emission of a first physical problem signal if the deviation between the measured value and the calculated average value for this parameter is less than a negative lower threshold associated with said parameter and if the deviation between the measured value and a reference value for another parameter of the set of representative parameters, possibly filtered using a phase advance filter, is greater than a positive upper threshold associated with said other parameter, the reference value preferably being chosen from among the calculated average value for said other parameter or a setpoint value of said other parameter;
the emission of a first measurement drift signal if the deviation between the measured value and the calculated average value for this parameter is less than said negative lower threshold associated with said parameter, and if the deviation between the measured value and the reference value for the other parameter, possibly filtered using a phase advance filter, is not greater than said positive upper threshold associated with said other parameter;
the emission of a second physical problem signal if the deviation between the measured value and the calculated average value for this parameter is greater than a positive upper threshold associated with said parameter and if the deviation between the measured value and the reference value for the other parameter, possibly filtered using a phase advance filter, is less than a negative lower threshold associated with said other parameter; and/or
the emission of a second measurement drift signal if the deviation between the measured value and the calculated average value for this parameter is greater than a positive upper threshold and if the deviation between the measured value and the reference value for the other parameter, possibly filtered using a phase advance filter, is not less than said negative lower threshold.

In one example of the embodiment, the monitoring method comprises the emission of an alarm signal if the deviation between the measured value and a reference value for this parameter, chosen, for example, from among the average value calculated for this parameter or a setpoint value for this parameter, possibly filtered using a phase advance filter, is less than a lower alarm threshold and/or the emission of an alarm signal if the deviation between the measured value and the reference value for this parameter, possibly filtered using a phase advance filter, is greater than an upper alarm threshold.

In one example of the embodiment, the monitoring method comprises the emission of a deviation signal if the deviation between the measured value and a reference value for this parameter chosen, for example, from among the average value calculated for this parameter or a setpoint value for this parameter, possibly filtered using a phase advance filter, is less than a lower deviation threshold and/or emission of a deviation signal if the deviation between the measured value and the reference value, possibly filtered using a phase advance filter, is greater than an upper deviation threshold.

For characterization of an imbalance using the comparison of a deviation between the measured value and a reference value of a parameter (for example, the calculated average value for this parameter or a setpoint value of this parameter) to a lower threshold and an upper threshold (for example, a negative threshold and a positive threshold), it is possible to issue the same deviation signal or the same alarm signal whenever the deviation between the measured value and the reference value is less than the lower threshold or greater than the upper threshold, or to issue a first deviation signal or a first alarm signal if the deviation is less than the lower threshold, and to issue a second deviation signal or a second alarm signal if the deviation is greater than the upper threshold.

During a comparison, the use of a phase advance filter applied to a deviation between the measured value and the reference value allows to anticipate the crossing of a threshold for this deviation, that is, the crossing below a lower threshold or above an upper threshold, in particular, to take this into account in the characterization of an imbalance of another parameter of the set of representative parameters.

In particular, for each steam generator 8, and for at least one parameter from among the set of representative parameters, it is possible, for example, to use deviation thresholds for the emission of a deviation signal used to characterize the imbalance of this parameter, and alarm thresholds for the emission of an alarm signal used to detect an imbalance of another parameter of the steam generator and characterize the imbalance of said parameter.

For the same parameter, each deviation threshold is preferably greater than or equal to, in absolute value, the corresponding alarm threshold.

Thus, a low-value deviation of a steam generator parameter can trigger the emission of an alarm signal that can be used to characterize an imbalance resulting in a high-value deviation of another steam generator parameter.

The low-value deviation of this parameter does not necessarily require the emission of a physical problem signal or a drift signal for this parameter but may allow to characterize an imbalance on the other parameter, in order to decide whether the deviation on this other parameter is linked to a physical problem or a measurement drift.

In one example of the embodiment, for each steam generator 8, the characterization of an imbalance on one parameter is, for example, carried out as a function of one or more alarm signals and/or one or more deviation signals issued for this parameter and for each other parameter taken into consideration for the detection of a potential imbalance on the parameter under consideration, according to the conditions indicated above, and for example using logic gates (“or” gate(s), “and” gate(s), inverting gate(s)) or truth tables or software code instructions encoding the conditions indicated above.

The set of parameters representative of the operation of a steam generator 8 comprises, for example, the primary power P1 which is a function, for each steam generator 8, of the water flow Q1 in the primary loop 12, the water temperature in the cold branch TF of the primary loop 12 and the water temperature in the hot branch TC of the primary loop 12.

In one example of the embodiment, the primary power P1 is used to characterize an imbalance in at least one other parameter from among the set of representative parameters.

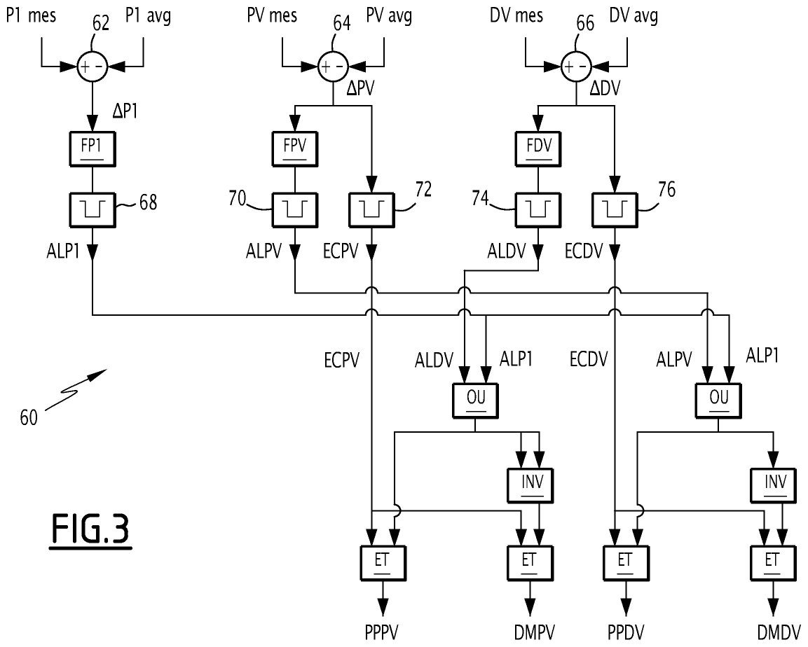

The monitoring method then comprises, as illustrated in FIG. 3, for each steam generator 8, calculating a measured primary power P1mes as a function of the measured water flow Q1mes, the measured cold loop water temperature TFmes and the measured hot branch water temperature TCmes (according to the primary power calculation formula indicated above), and calculating an average primary power P1avg as the average of the measured primary powers P1mes.

For each steam generator 8, the monitoring method comprises calculating a primary power deviation ΔP1 as the difference between the measured primary power P1mes for that steam generator 8 and the average primary power P1avg.

For each steam generator 8, the monitoring method comprises generating a primary power alarm signal ALP1 if the primary power deviation ΔP1, possibly after filtering using a primary power phase advance filter FP1, passes below a lower primary power alarm threshold SALP1inf or above an upper primary power alarm threshold SALP1sup.

In one example of implementation, the method for monitoring comprises, for each steam generator 8, calculating a steam pressure deviation ΔPV as the difference between the measured steam pressure PVmes for this steam generator 8 and the average steam pressure PVavg for all the steam generators 8, and calculating a steam flow deviation ΔDV as the difference between the measured steam flow DVmes of this steam generator 8 and the mean steam flow DVavg for all the steam generators 8.

For each steam generator 8, the characterization of an imbalance on the steam pressure PV on this steam generator 8 comprises, for example:
the emission of a physical steam pressure problem signal PPPV if the steam pressure deviation ΔPV of this steam generator 8 is less than a lower steam pressure deviation threshold SECPVinf or greater than an upper steam pressure deviation threshold SECPVsup, and, furthermore, if the steam flow deviation ΔDV of this steam generator 8, possibly filtered using a steam flow phase advance filter FDV, is less than a lower steam flow alarm threshold SALDVinf or greater than an upper steam flow alarm threshold SALDVsup or if the primary power deviation ΔP1 of this steam generator 8, possibly filtered using a primary power phase advance filter FP1, is less than a lower primary power alarm threshold SALP1inf or greater than an upper primary power alarm threshold SALP1sup; and/or
the emission of a steam pressure measurement drift signal DMPV if the steam pressure deviation ΔPV of this steam generator 8 is less than the lower steam pressure deviation threshold SECPVinf or greater than the upper steam pressure deviation threshold SECPVsup, and, furthermore, if the steam flow deviation ΔDV of this steam generator 8, possibly filtered using a steam flow phase advance filter FDV, is not less than the lower steam flow alarm threshold SALDVinf nor greater than the upper steam flow alarm threshold SALDVsup, and if the primary power deviation ΔP1 of this steam generator 8, possibly filtered using the primary power phase advance filter FP1, is not less than the lower primary power alarm threshold SALP1inf nor greater than the upper primary power alarm threshold SALP1sup.

For each steam generator 8, characterizing an imbalance in the steam flow DV on this steam generator 8 comprises, for example:
the emission of a physical steam flow problem signal PPDV if the steam flow deviation ΔDV of this steam generator 8 is less than a lower steam flow deviation threshold SECDVinf or greater than an upper steam flow deviation threshold SECDVsup, and, furthermore, if the steam pressure deviation ΔPV of this steam generator 8, possibly filtered using a steam pressure phase advance filter FPV, is less than a lower steam pressure alarm threshold SALPVinf or greater than an upper steam pressure alarm threshold SALPVsup or if the primary power deviation ΔP1 of this steam generator 8, possibly filtered using the primary power phase advance filter FP1, is less than the lower primary power alarm threshold SAP1inf or greater than the upper primary power alarm threshold SAP1sup; and/or
the emission of a steam flow measurement drift signal DMDV if the steam flow deviation ΔDV of this steam generator 8 is less than the lower steam flow deviation threshold SECDVinf or greater than the upper steam flow deviation threshold SCDVsup, and, furthermore, if the steam pressure deviation ΔPV of this steam generator 8, possibly filtered using a phase advance filter, is not less than the lower steam pressure alarm threshold SALPVinf nor greater than an upper steam pressure alarm threshold SALPVsup, and if the primary power deviation ΔP1 of this steam generator 8, possibly filtered using a primary power phase advance filter FP1, is not less than the lower primary power alarm threshold SALP1inf nor greater than the upper primary power alarm threshold SALP1sup.

Preferably, the deviation thresholds and the alarm thresholds taken into account to characterize an imbalance on the steam pressure PV are different.

Preferably, the absolute value of each deviation threshold (lower steam pressure deviation threshold SECPVinf and upper steam pressure deviation threshold SECPVsup) is greater than or equal to that of the corresponding alarm threshold (lower steam pressure alarm threshold SALPVinf and upper steam pressure alarm threshold SALPVsup respectively).

Preferably, the deviation thresholds and alarm thresholds taken into account to characterize an imbalance on the steam flow DV are different.

Preferably, the absolute value of each deviation threshold (lower steam flow deviation threshold SECDVinf and upper steam flow deviation threshold SECDVsup) is greater than or equal to that of the corresponding alarm threshold (lower steam flow alarm threshold SALDVinf and upper steam flow alarm threshold SALDVsup respectively).

In one example of the embodiment, the monitoring method comprises, for each steam generator 8:
the emission of a primary power alarm signal ALP1 if the primary power deviation ΔP1 of this steam generator 8, possibly filtered using the primary power phase advance filter FP1, is less than the lower primary power alarm threshold SALP1inf or greater than the upper primary power alarm threshold SALP1sup;
the emission of a steam pressure alarm signal ALPV if the steam pressure deviation ΔPV of this steam generator 8, possibly filtered by means of the steam pressure phase advance filter FPV, is less than the lower steam pressure alarm threshold SALPVinf or greater than the upper steam pressure alarm threshold SALPVsup;
the emission of a steam pressure deviation signal ECPV if the steam pressure deviation ΔPV of this steam generator 8 is less than the lower steam pressure deviation threshold SECPVinf or greater than the upper steam pressure deviation threshold SECPVsup,
the emission of a steam flow alarm signal ALDV if the steam flow deviation ΔDV of this steam generator 8, possibly filtered with the steam flow phase advance filter FDV, is less than the lower steam flow alarm threshold SALDVinf or greater than the upper steam flow alarm threshold SALDVsup; and/or
the emission of a steam flow deviation signal ECDV if the steam flow deviation ΔDV of this steam generator 8 is lower than the lower steam flow deviation threshold SECDVinf or higher than the upper steam flow deviation threshold SECDVsup.

In one example of the embodiment, for each steam generator 8, the characterization of an imbalance in the steam pressure PV or an imbalance in the steam flow DV is carried out, for example, as a function of the alarm signals (ALP1, ALPV, ALDV) and as a function of the deviation signals (ECPV, ECDV), according to the conditions indicated above, and for example using logic gates (“or” gate(s), “and” gate(s), inverting gate(s), . . . ) or truth tables, or software code instructions encoding the previously specified conditions.

FIG. 3 illustrates an electronic monitoring unit 60 configured to characterize an imbalance of a steam pressure or an imbalance of a steam flow, as a function of the alarm signal(s) and as a function of the deviation signal(s), using logic gates.

As illustrated in FIG. 3, the electronic monitoring unit 60 comprises, for each steam generator 8, a primary power differential comparator 62 for calculating the primary power deviation ΔP1, a steam pressure differential comparator 64 for calculating the steam pressure deviation ΔPV, and a steam flow differential comparator 66 for calculating the steam flow deviation ΔDV.

The electronic monitoring unit 60 further comprises a primary power alarm threshold comparator 68 for the emission of the primary power alarm signal ALP1, a steam pressure alarm threshold comparator 70 for the emission of the steam pressure alarm signal ALPV, a steam pressure deviation threshold comparator 72 for the emission of the steam pressure deviation signal ECPV, a steam flow alarm threshold comparator 74 for the emission of the steam flow alarm signal ALDV, and/or a steam flow deviation threshold comparator 76 for the emission of the steam flow deviation signal ECDV.

Each threshold comparator emits the corresponding alarm signal or deviation signal, as a function of the emission conditions indicated above, in the form of a logic signal.

The electronic monitoring unit 60 comprises logic gates for the emission of physical problem signals PPPV, PPDV and measurement drift signals DMPV, DMDV as a function of the alarm signals and the deviation signals emitted by the threshold comparators, according to the criteria indicated above.

In one example of implementation, the method of monitoring comprises, for each steam generator 8, calculating a feed water temperature deviation ΔTE as the difference between the measured feed water temperature TEmes for this steam generator 8 and the average feed water temperature TEavg for all the steam generators 8.

For each steam generator 8, characterizing an imbalance in the feed water temperature of this steam generator 8 comprises, for example:
the emission of a physical feed water temperature problem signal PPTE if the feed water temperature deviation ΔTE of this steam generator 8 is less than a lower feed water temperature deviation threshold SECTEinf or greater than an upper feed water temperature deviation threshold SECTEsup, and if the primary power deviation ΔP1 of this steam generator 8 is less than the lower primary power alarm threshold SALP1inf or greater than the upper primary power alarm threshold SALP1sup; and/or
the emission of a feed water temperature measurement drift signal DMTE if the feed water temperature deviation ΔTE of this steam generator 8 is less than a lower feed water temperature deviation threshold SECTEinf or greater than an upper feed water temperature deviation threshold SECTEsup, and if the primary power deviation ΔP1 of this steam generator 8 is not less than the lower primary power alarm threshold SALP1inf nor greater than the upper primary power alarm threshold SALP1sup.

In one example of the embodiment, the monitoring method comprises, for each steam generator 8, the emission of a feed water temperature deviation signal ECTE if the feed water temperature deviation ΔTE is less than the lower feed water temperature deviation threshold SECTEinf or greater than the upper feed water temperature deviation threshold SECTEsup.

For example, the monitoring method comprises, for each steam generator 8, characterizing an imbalance of the feed water temperature as a function of the feed water temperature deviation signal ECTE and the primary power alarm signal ALP1, according to the conditions indicated above, and, for example, using logic gates (“or” gate(s), “and” gate(s), inverting gate(s), etc.) or truth tables or software code instructions encoding the conditions indicated above.

Alternatively, the monitoring method comprises, for each steam generator 8, the emission of a feed water temperature alarm signal ALTE if the feed water temperature deviation ΔTE, possibly filtered using a feed water temperature phase advance filter FTE, is less than the lower feed water temperature alarm threshold SALTEinf or greater than the upper feed water temperature alarm threshold SALTEsup.

Preferably, each deviation threshold (lower feed water temperature deviation threshold SECTEinf and upper feed water temperature deviation threshold SECTEsup) and the corresponding alarm threshold (lower feed water temperature alarm threshold SALTEinf and the upper feed water temperature alarm threshold SALTEsup) are different, the deviation threshold preferably being greater than or equal, in absolute value, to the corresponding alarm threshold.

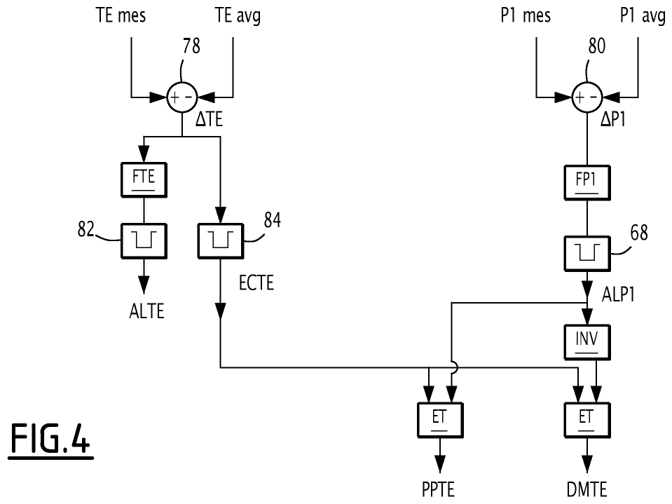

FIG. 4 illustrates an electronic monitoring unit 60 configured to characterize an imbalance in the feed water temperature of a steam generator 8 as a function of the alarm signal(s) and as a function of the deviation signal(s), using logic gates.

As illustrated in FIG. 4, the electronic monitoring unit 60 comprises, for each steam generator 8, a differential feed water temperature comparator 78 for calculating the deviation of the water temperature of this steam generator 8.

The electronic monitoring unit 60 further comprises a primary power alarm threshold comparator 68 for emitting the primary power alarm signal ALP1, a feed water temperature alarm threshold comparator 82 for emitting the feed water temperature alarm signal ALTE, and/or a feed water temperature deviation threshold comparator 84 for emitting the feed water temperature deviation signal ECTE.

Each threshold comparator emits the corresponding alarm signal or deviation signal as a function of the emission conditions indicated above.

The electronic monitoring unit 60 comprises logic gates for emitting physical problem and measurement drift signals as a function of the alarm signals and deviation signals determined by the threshold comparators, according to the conditions indicated above.

The monitoring method comprises, for example, for each steam generator 8, the calculation of a water flow deviation ΔDE as the difference between the measured feed water flow DEmes of this steam generator 8 and the average feed water flow DEavg for all the steam generators 8.

The monitoring method further comprises, for each steam generator 8, calculating a water level deviation ΔNV as the difference between the measured water level NVmes of this steam generator 8 and a setpoint water level NVcons.

For each steam generator, the characterization of an imbalance on the feed water flow of this steam generator 8 is carried out as a function of, for example, the feed water flow deviation ΔDE and the water level deviation ΔNV of this steam generator 8.

For each steam generator 8, in one example of the embodiment, characterizing an imbalance on the feed water flow of the steam generator 8 comprises:
the emission of a low feed water flow physical problem signal PPDEneg if the feed water flow deviation ΔDE is less than a negative feed water flow deviation threshold SECDEneg and the water level deviation ΔNV, possibly filtered using a water level phase advance filter FNV, is less than a negative water level alarm threshold SALNVneg;
the emission of a low feed water flow measurement drift signal DMDEneg if the feed water flow deviation ΔDE is less than the negative feed water flow deviation threshold SECDEneg and the water level deviation ΔNV, possibly filtered using the water level phase advance filter FNV, is not less than the negative water level alarm threshold SALNVneg;
the emission of a high feed water flow physical problem signal PPDEpos if the feed water flow deviation is greater than a positive feed water flow deviation threshold SECDEpos and the water level difference, possibly filtered using the FNV water level phase advance filter, is greater than a positive water level alarm threshold SALNVpos; and/or
the emission of a high feed water flow measurement drift signal DMDEpos if the feed water flow difference ΔDE is greater than the positive feed water flow threshold SECDEpos and the water level deviation ΔNV, possibly filtered using the water level phase advance filter FNV, is not greater than a positive water level alarm threshold SALNVpos.

In one example of the embodiment, the monitoring method comprises, for each steam generator 8:
the emission of a negative feed water flow deviation signal ECDEneg if the feed water flow deviation ΔDE is less than the negative feed water flow deviation threshold SECDEneg;
the emission of a positive feed water flow deviation signal ECDEpos if the feed water flow deviation ΔDE is greater than a positive feed water flow deviation threshold SECDEpos;
the emission of a negative feed water flow alarm signal ALDEneg if the feed water flow deviation ΔDE, possibly filtered using the feed water flow phase advance filter FDE, is less than a negative feed water flow alarm threshold SALDEneg;
the emission of a positive feed water flow alarm signal ALDEpos if the feed water flow deviation ΔDE, possibly filtered using the feed water flow phase advance filter FDE, is greater than a positive feed water flow alarm threshold SALDEpos; and/or
the emission of a comparative flow deviation signal ECDC if the feed water flow deviation ΔDE, possibly filtered using a comparative flow phase advance filter FDC, is less than a comparative flow deviation threshold SECDCinf or greater than an upper comparative flow deviation threshold SECDCsup.

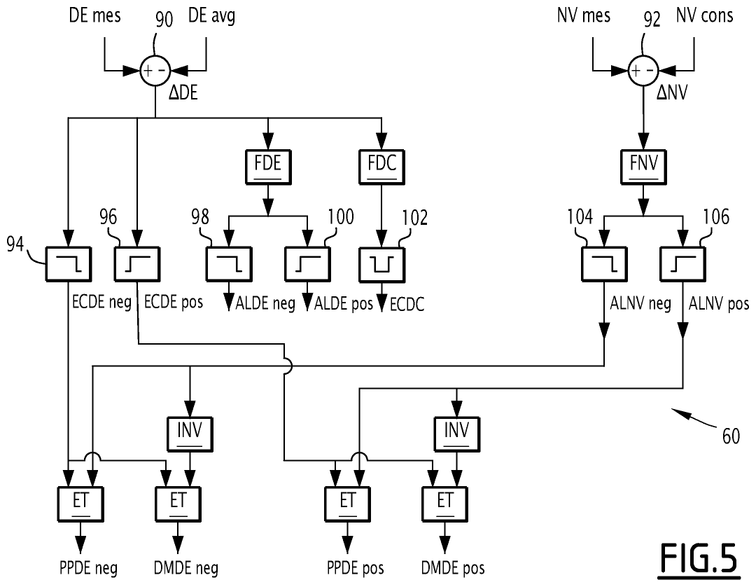

Furthermore, as illustrated in FIG. 5, the method comprises, for example, the emission of a negative water level deviation alarm signal ALNVneg if the water level deviation ΔNV, possibly filtered using the water level phase advance filter FNV, is less than the negative water level alarm threshold SALNVneg and the emission of a positive water level deviation alarm signal ALNVpos if the water level deviation ΔNV, possibly filtered using the water level phase advance filter FNV, is greater than the positive water level alarm threshold SALNVpos.

Preferably, each feed water flow deviation threshold (negative feed water flow deviation threshold and positive feed water flow deviation threshold) and the corresponding alarm threshold (negative feed water flow alarm threshold and positive feed water flow alarm threshold respectively) are different. In particular, as an absolute value, each deviation threshold is preferably greater than the corresponding alarm threshold.

The monitoring method comprises, for example, for each steam generator 8, characterization of an imbalance in the feed water flow DE as a function of deviation signals relating to the feed water flow DE (negative feed water flow deviation signal ECDEneg and positive feed water flow deviation signal ECDEpos) and as a function of alarm signals relating to the water level (negative water level alarm signal ALNVneg and positive water level alarm signal ALNVpos), according to the conditions specified above, for example using logic gates (“or” gate(s), “and” gate(s), inverting gate(s) . . . ) or truth tables or software code instructions encoding the previously specified conditions.

In one example of implementation, the monitoring method comprises, for each steam generator 8, calculating a purge flow deviation ΔDP as a difference between the measured purge flow DPmes of this steam generator 8 and the average purge flow DPavg for all the steam generators 8.

For each steam generator 8, the monitoring method comprises, for example:
the emission of a physical purge flow problem signal PPDP if the purge flow deviation ΔDP passes below a lower purge flow deviation threshold SECDPinf or above an upper purge flow deviation threshold SECDPsup, and if the feed water flow deviation ΔDE of this steam generator 8, possibly filtered using the comparative flow phase advance filter FDC, is less than the lower comparative flow deviation threshold SECDCinf or greater than the upper comparative flow deviation threshold SECDCsup; and/or
the emission of a purge flow measurement drift signal DMDP if the purge flow deviation ΔDP of this steam generator passes below a lower purge flow deviation threshold SECDPinf or above an upper purge flow deviation threshold SECDPsup, and if the feed water flow deviation ΔDE of this steam generator 8, possibly filtered using the comparative flow phase advance filter FDC, is not less than the lower comparative flow deviation threshold SECDCinf nor greater than the upper comparative flow deviation threshold SECDCsup.

In particular, when the monitoring method comprises the possible emission of a comparative feed water flow deviation signal ECDC emitted or not (that is, absent) according to the conditions indicated above, the monitoring method comprises, for example, for each steam generator 8:
the emission of a physical purge flow problem signal PPDP if the purge flow deviation ΔDP passes below a lower purge flow deviation threshold SECDPinf or above an upper purge flow deviation threshold SECDPsup, and if the compared feed water flow deviation signal ECDC is present; and/or
the emission of a purge flow measurement drift signal DMDP if the purge flow deviation ΔDP of this steam generator passes below a lower purge flow deviation threshold SECDPinf or above an upper purge flow deviation threshold SECDPsup, and if the compared feed water flow deviation signal ECDC is absent.

In one example of the embodiment, the monitoring method comprises the emission of a purge flow deviation signal ECDP if the purge flow deviation passes below the lower purge flow deviation threshold SECDPinf or above the upper purge flow deviation threshold SECDPsup.

Furthermore, the monitoring method comprises, for example, for each steam generator 8, characterizing an imbalance of the purge flow as a function of the purge flow deviation signal ECDP and the compared flow deviation signal ECDC, according to the conditions indicated above, and for example using logic gates (“or” gate(s), “and” gate(s), inverse gate, etc.) or truth tables or software code instructions encoding the conditions indicated above.

Optionally, the monitoring method comprises, for each steam generator 8, the emission of a purge flow alarm signal ALDP if the purge flow deviation ΔDP, possibly filtered using a purge flow phase advance filter FDP, is less than the lower purge flow alarm threshold SALDPinf or greater than the upper purge flow alarm threshold SALDPsup.

Preferably, each deviation threshold (lower purge flow deviation threshold SECDPinf and upper purge flow deviation threshold SECDPsup) is greater than or equal to, in absolute value, to the corresponding alarm threshold (lower purge flow alarm threshold SALDPinf and upper purge flow alarm threshold SALDPsup).

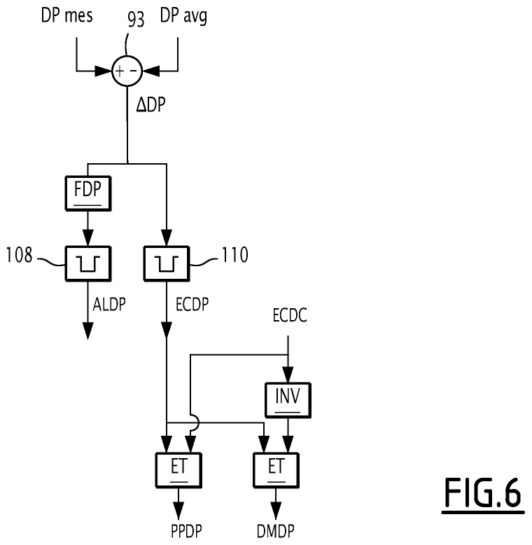

FIGS. 5 and 6 illustrate an electronic monitoring unit 60 configured to implement the monitoring method, and in particular to characterize an imbalance in the feed water flow and/or purge flow of a steam generator 8 as a function of the alarm signal(s) and as a function of the deviation signal(s), using logic gates.

As illustrated in FIGS. 5 and 6, the electronic monitoring unit 60 comprises, for each steam generator 8, a differential feed water flow comparator 90 (FIG. 5) for calculating the feed water flow deviation of this steam generator 8, a differential water level flow comparator 92 (FIG. 5) for calculating the difference between the water level measurement NVmes and the water level setpoint NVcons of this steam generator 8, and a differential purge flow comparator 93 (FIG. 6) for calculating the purge flow deviation of this steam generator 8.

The electronic monitoring unit 60 further comprises (FIG. 5) a negative threshold feed water flow deviation comparator 94 for emitting the negative feed water flow deviation signal ECDEneg, a positive threshold feed water flow deviation comparator 96 for emitting the positive feed water flow deviation signal ECDEpos, a negative threshold feed water flow alarm comparator 98 for emitting the negative feed water flow deviation alarm signal ALDEneg, a comparator with a positive threshold feed water flow alarm comparator 100 for emitting the alarm signal indicating a positive feed water flow deviation ΔLDEpos, a comparative flow threshold comparator 102 for emitting the comparative flow deviation signal ECDC, a negative water level threshold comparator 104 for emitting the alarm signal indicating a negative measure-set water level difference ALNVneg, and/or a positive water level threshold comparator 106 for emitting the alarm signal indicating a positive measure-set water level difference ALNVpos.

The electronic monitoring unit 60 further comprises (FIG. 6), a purge flow alarm threshold comparator 108 for emitting the purge flow alarm signal ALDP and a purge flow deviation threshold comparator 110 for emitting the purge flow deviation signal ECDP.

Each threshold comparator emits the corresponding alarm signal or deviation signal as a function of the emission conditions indicated above.

The electronic monitoring unit 60 comprises logic gates for emitting physical problem and measurement drift signals as a function of the alarm signals and the deviation signals determined by the threshold comparators, according to the criteria indicated above.

By comparing the measured value of a parameter of a steam generator 8 with the average value of this parameter over all steam generators 8, it allows an imbalance of this parameter on this steam generator 8 to be identified relative to the other steam generators 8.

Such an imbalance may be due to a physical problem on this steam generator 8, that is, a problem actually present on this steam generator 8 affected by the imbalance, or to a measurement drift of said parameter on this steam generator 8.

Each other parameter taken into account for the characterization of an imbalance detected on a parameter is preferably another parameter related to said parameter on which an imbalance is detected, and which should also be affected by the imbalance.

Thus, as indicated above:
the characterization of an imbalance on the steam pressure of a steam generator 8 is carried out, for example, as a function of the steam flow and the primary power, in particular as a function of a deviation between the measured steam flow DVmes of this steam generator 8 and the average steam flow DVavg of all the steam generators 8 and a deviation between the measured primary power P1mes of this steam generator 8 and the average primary power P1avg for all the steam generators 8;
the characterization of an imbalance in the steam flow of a steam generator 8 is carried out as a function of, for example, the steam pressure and the primary power, in particular as a function of a deviation between the measured steam pressure PVmes of this steam generator 8 and the average steam pressure PVavg of all the steam generators 8, and of a deviation between the measured primary power P1mes of this steam generator 8 and the average primary power P1avg of all the steam generators 8;
the characterization of an imbalance in the feed water temperature of a steam generator 8 is carried out, for example, as a function of the primary power, in particular as a function of a deviation between the measured primary power P1mes of this steam generator 8 and the average primary power P1avg of all the steam generators 8;
the characterization of an imbalance in the feed water flow of a steam generator 8 is carried out, for example, as a function of the water level of this steam generator 8, in particular as a function of a deviation between a measured water level NVmes of this steam generator 8 and a setpoint water level NVcons; and/or
the characterization of an imbalance in the purge flow of a steam generator 8 is carried out, for example, as a function of the feed water flow of this steam generator 8, in particular as a function of a deviation between the measured feed water flow DEmes of this steam generator 8 and the average feed water flow DEavg of all the steam generators 8.

Characterizing the imbalance in a parameter of a steam generator 8 as a function of one or more other parameter(s) allows the monitoring system 40 to automatically generate a signal indicating that the imbalance detected is due to a physical problem on the steam generator or to a drift in the measurement of this parameter on this steam generator.

Each alarm signal, each deviation signal, each physical problem signal and/or each measurement drift signal allows an actual or potential imbalance between the steam generators 8 to be detected.

The use of phase advance filters in the processing of measurements provided by some of the sensors allows, in particular, potential problems to be anticipated, which allows a human operator to be better prepared for the appearance of a more significant deviation on a particular parameter.

Each alarm signal, each deviation signal, each physical problem signal and/or each measurement drift signal relating to a parameter is determined as a function of one or more other parameter(s), which allows said signals to be generated in a timely manner.

Preferably, at least one, and in particular, each, of the following parameters is the subject of characterization may lead to the emission of an alarm signal, a deviation signal, a physical problem signal and/or a measurement drift signal: the steam pressure PV, the steam flow DV, the feed water temperature TE, the feed water flow DE and the purge flow DP.

Each of these parameters, characterized by taking into account another parameter, allows to detect, possibly anticipate, the appearance of an imbalance in the steam generator operation.

In one example of the embodiment, each alarm signal, each deviation signal, each physical problem signal and/or each measurement drift signal is emitted in such a way as to be perceptible to a human operator, for example in the form of a visual signal, an audible signal and/or a tactile signal. The operator can thus take any necessary action.

Each alarm signal, each deviation signal, each physical problem signal and/or each measurement drift signal emitted in such a way as to be perceptible to a human operator is, for example, emitted by means of a human machine interface. The human machine interface comprises, for example, a display screen, a control panel and/or a sound emitting device.

The characterization of the imbalance, once confirmed, allows an operator or the monitoring system, when the latter is configured to control the nuclear plant 2, to take appropriate measures following the detection and confirmation of an imbalance, according to whether it is a physical problem or a measurement drift.

In the case of characterization of a physical problem, the nuclear plant 2 can be controlled to compensate for the physical problem, or the nuclear plant 2 can be switched to an operating mode allowing the physical problem to be corrected.

In the case of characterization of a measurement drift, it is possible to take into account the drift to correct the measurement signals supplied by the sensor(s) involved, or the faulty equipment can be serviced (repaired or replaced) in an operating or shutdown state.

The monitoring method according to the present disclosure allows the human operator to be supplied with an aid for controlling the nuclear plant.

Each alarm signal, each deviation signal, each physical problem signal and/or each measurement drift signal emitted in such a way as to be perceptible to a human operator allows to alert the human operator in the case unbalanced operation of one of the steam generators 8 of the nuclear plant 2.

Each alarm signal, each deviation signal, each physical problem signal and/or each measurement drift signal emitted for the attention of the human operator helps the latter to establish a diagnosis, for example by allowing the origin of the reported problem to be located (that is, to determine which part of the nuclear plant 2 may be at the origin of the reported problem) and the cause of the reported problem (that is, what is the reason for the reported problem: physical problem or measurement drift).

Each alarm signal, each deviation signal, each physical problem signal and/or each measurement drift signal emitted in such a way as to be perceptible to a human operator allows to help in the search for a possible leak in the primary or secondary circuit and/or to alert the human operator in the event of unbalanced operation of one of the steam generators 8 of the nuclear plant 2.

What is claimed is:

1-18. (canceled)

19: A monitoring method of a nuclear plant implemented by a monitoring system,
the nuclear plant having a primary circuit, a secondary circuit, a nuclear reactor arranged in the primary circuit to heat water circulating in the primary circuit, and N steam generators arranged to transfer heat from the primary circuit to the secondary circuit by generating steam in the secondary circuit, N being an integer equal to or greater than 2, the monitoring system comprising sensors for measuring, for each steam generator, parameters of a set of parameters representative of an operation of the steam generator, the monitoring method comprising, for at least one of the parameters of the set of representative parameters, and for each steam generator:
determining, as a function of measurements supplied by the sensors, a deviation between a measured value of the parameter for this steam generator and an average value of this parameter for all the steam generators, for detecting an imbalance of this parameter on the steam generator; and
characterizing the imbalance affecting this parameter of this steam generator as a function of one or more other parameter(s) of the set of representative parameters, so as to generate a physical problem signal indicative of a presence of a physical problem on the steam generator affected by the imbalance or a measurement drift signal indicative of a drift in the measurement of the parameter under consideration on the steam generator affected by the imbalance.

20: The monitoring method according to claim 19, wherein, for at least one of the parameters of the set of representative parameters, the characterization of an imbalance of the parameter is carried out as a function, for at least one or each of said other parameter(s), of a deviation between a measured value of this other parameter for the steam generator under consideration and a reference value of this other parameter for all the steam generators, the reference value being chosen from among an average value of this other parameter and a setpoint value of this other parameter.

21: The monitoring method according to claim 19, comprising comparing at least one of or each deviation between a measured value and a reference value of a parameter with one or more comparison thresholds, to detect an imbalance on this parameter or to detect an imbalance on another parameter, the reference value being chosen from among an average value and a setpoint value of this parameter.

22: The monitoring method according to claim 19, wherein, for at least one of the parameters of the set of representative parameters, characterization of the imbalance of the parameter on the steam generator under consideration comprises:
emitting a physical problem signal if the deviation between the measured value and the average value for this parameter is less than a lower threshold associated with this parameter or greater than an upper threshold associated with this parameter, and if the deviation between the measured value and a reference value of another parameter of the set of representative parameters is less than a lower threshold associated with this other parameter or greater than an upper threshold associated with this other parameter; and/or
emitting a measurement drift signal if the deviation calculated for this parameter is less than a lower threshold associated with this parameter or greater than an upper threshold associated with this parameter, and if the deviation between the measured value and a reference value of another parameter of the set of representative parameters is not less than the lower threshold associated with this other parameter nor greater than the upper threshold associated with this other parameter.

23: The monitoring method according to claim 22, wherein:
in the step of emitting a physical problem signal, the reference value of the other parameter of the set of representative parameters is chosen from among the average value calculated for this other parameter and a setpoint value of this other parameter; and/or
in the step of emitting a measurement drift signal, the reference value of the other parameter of the set of representative parameters is chosen from among the average value calculated for said other parameter and a setpoint value of said other parameter.

24: The monitoring method according to claim 19, wherein, for each steam generator, and for at least one of the parameters of the set of representative parameters, characterization of an imbalance of this parameter on this steam generator comprising:
emitting a first physical problem signal if the deviation between the measured value and the average value for this parameter is less than a negative lower threshold, and if the deviation between the measured value and a reference value of another parameter of the set of representative parameters is less than a negative lower threshold;
emitting a first measurement drift signal if the deviation between the measured value and the average value for this parameter is less than the negative lower threshold, and if the deviation between the measured value and the reference value for the other parameter is not less than the negative lower threshold;
emitting a second physical problem signal if the deviation between the measured value and the average value for this parameter is greater than a positive upper threshold, and if the deviation between the measured value and the reference value for the other parameter is greater than a positive upper threshold; and/or
emitting a second measurement drift signal if the deviation between the measured value and the average value for this parameter is greater than a positive upper threshold and if the deviation between the measured value and the reference value for the other parameter is not greater than the positive upper threshold.

25: The monitoring method according to claim 24, wherein in the step of emitting a first physical problem signal, the other parameter of the set of representative parameters is chosen from among the calculated average value for this other parameter and a setpoint value of this other parameter.

26: The monitoring method according to claim 19, for each steam generator and for at least one of the parameters of the set of representative parameters, emitting an alarm signal if the deviation between the measured value and a reference value is less than a lower alarm threshold and/or the emission of an alarm signal if the deviation between the measured value and the reference value is greater than an upper alarm threshold, the reference value being chosen from among an average value of this parameter and a setpoint value of this parameter.

27: The monitoring method according to claim 26, wherein the deviation between the measured value and the reference value is filtered using a phase advance filter before being compared with the lower alarm threshold and/or before being compared with the upper alarm threshold.

28: The monitoring method according to claim 27, wherein the characterization of an imbalance on at least one of or each of the parameters of the set of representative parameters comprises taking into account an alarm signal emitted for another parameter of the set of representative parameters.

29: The monitoring method according to claim 19, for each steam generator and for at least one of the parameters of the set of representative parameters, emitting a deviation signal if the deviation between the measured value and a reference value of this parameter is less than a lower deviation threshold and/or the emission of a deviation signal if the deviation between the measured value and the reference value of this parameter is greater than an upper deviation threshold, the reference value being chosen from among an average value of this parameter and a setpoint value of this parameter.

30: The monitoring method according to claim 26, wherein
for each steam generator and for at least one of the parameters of the set of representative parameters, the emission of a deviation signal if the deviation between the measured value and a reference value of this parameter is less than a lower deviation threshold and/or the emission of a deviation signal if the deviation between the measured value and the reference value of this parameter is greater than an upper deviation threshold, the reference value being chosen from among an average value of this parameter and a setpoint value of this parameter; and
the characterization of an imbalance of at least one of the parameters of a steam generator is carried out as a function of a deviation signal emitted for this parameter and of an alarm or deviation signal emitted for at least one other parameter taken into account for the characterization.

31: The monitoring method according to claim 19, wherein, for each steam generator, the set of representative parameters comprises one or more of the following parameters: steam flow, steam pressure, feed water flow, feed water temperature, purge flow, water level in liquid state and primary power.

32: The monitoring method according to claim 31, wherein the characterization of an imbalance on the steam pressure of a steam generator is carried out as a function of the steam flow and the primary power, in particular as a function of a deviation between the measured steam flow of this steam generator and the average steam flow of the steam generators, and a deviation between the measured primary power of this steam generator and the average primary power for all the steam generators.

33: The monitoring method according to claim 31, wherein the characterization of an imbalance on the steam flow of a steam generator is carried out as a function of the steam pressure and the primary power, in particular as a function of a deviation between the measured steam pressure of this steam generator and the average steam pressure of all the steam generators, and a deviation between the measured primary power of this steam generator and the average primary power of all the steam generators.

34: The method according to claim 31, wherein the characterization of an imbalance on the feed water temperature of a steam generator is carried out as a function of the primary power.

35: The method according to claim 34, wherein the characterization of the imbalance on the feed water temperature of a steam generator is carried out as a function of a deviation between the measured primary power of this steam generator and the average primary power of all the steam generators.

36: The method according to claim 31, wherein the characterization of an imbalance on the feed water flow of a steam generator is carried out as a function of the water level of this steam generator.

37: The method according to claim 36, wherein the characterization of an imbalance on the feed water flow of a steam generator is carried out as a function of a deviation between a measured water level of this steam generator and a water level setpoint (NVcons).

38: The method according to claim 37, wherein the characterization of an imbalance on the purge flow of a steam generator is carried out as a function of the feed water flow of this steam generator.

39: The method according to claim 38, wherein the characterization of an imbalance on the purge flow of a steam generator is carried out as a function of a deviation between the measured feed water flow of this steam generator and the average feed water flow of all the steam generators.

40: A system for monitoring a nuclear plant comprising sensors for measuring, for each steam generator, parameters from the set of representative parameters, and an electronic monitoring unit configured to implement a monitoring method according to claim 19 on the basis of measurements provided by the sensors.

41: A computer program product recordable on a computer memory or data carrier and executable by a processor or computer, the computer program product comprising software code instructions for implementing a monitoring method according to claim 19.
